(19) United States
(12) Patent Application Publication
(10) Pub. No.: US 2025/0327680 A1
(43) Pub. Date: Oct. 23, 2025

(54) ROUTE PLANNING FOR AUTONOMOUS VEHICLES

(71) Applicant: DISH Wireless L.L.C., Englewood, CO (US)

(72) Inventor: Gurpreet Sohi, Parker, CO (US)

(73) Assignee: DISH Wireless L.L.C., Englewood, CO (US)

(21) Appl. No.: 18/643,937

(22) Filed: Apr. 23, 2024

(51) Int. Cl. G01C 21/36; G06N 20/00; G06Q 10/047; H04L 47/11

(52) U.S. Cl. CPC G01C 21/362; G06N 20/00; G06Q 10/047; H04L 47/11

(57) ABSTRACT

A method and system for receiving, at an application function of a core network from a user equipment (UE) device communicatively coupled to an automated vehicle, a navigation destination for the automated vehicle; conducting, via one or more intelligent platforms, a network health check and route validation process to determine an optimized route from a current location of the automated vehicle to the received navigation destination based on communication network traffic data; assigning, at the application function, an optimized route with network quality (NQ) assurance; and transmitting, to the UE device, an instruction message containing the assigned optimized route.

### FIELD OF THE DISCLOSURE

The present disclosure relates to automated driving technology, and more particularly, to a system and method that improves route planning for autonomous vehicles.

### BACKGROUND OF THE DISCLOSURE

Autonomous vehicles rely on regular data updates for navigation, e.g., detailed road maps, as well as updates in unexpected traffic situations, such as congestion, rain, or black ice. As such, autonomous driving requires fast and reliable communication networks that can deliver such regular data updates. 5G networks provide the benefit of network slicing in which the wireless network is subdivided into virtual network levels. One network level can then be used only for automated driving, as an example. This ensures that safety-relevant notifications to self-driving cars will not end up in a traffic jam on the data highway and will be given priority over other infotainment services used in parallel. Another benefit is the data processing and storage in data centers that are in close proximity to the transport routes. Such “edge” data centers ensure that data can be processed faster in the network. The virtual network levels and short transmission paths can provide high quality of service (QOS) including low latencies and high bandwidths.

While 5G networks can enable fully automated driving, a problem occurs when due to communication congestion, malfunctions or other reasons, wireless network services along a route cannot provide sufficient QoS to ensure full driving information and safety.

It would therefore be advantageous to have some preparation for such eventualities so as to ensure safety and provide sufficient quality of service for automated driving.

### SUMMARY OF THE DISCLOSURE

The present disclosure provides for using one or more intelligent platforms to determine network traffic conditions at respective network sites and thereby map optimized routes for autonomous vehicles that ensure adequate network coverage and/or quality assurance (QA) for facilitating the operations of the autonomous vehicles along the optimized routes to their respective destinations.

In particular, the disclosure relates to a system and method that utilizes a machine learning (ML) process trained on historical network traffic at respective network sites to process current traffic data to ascertain network traffic conditions along one or more potential routes to a destination for an autonomous vehicle. Accordingly, taking into account predicted use of a particular site at different times of the day based on when an autonomous vehicle is expected to be proximate the site along the one or more potential routes, an optimized route that ensures adequate network coverage and/or QA is determined and assigned to the autonomous vehicle.

In a general aspect, a method is provided. The method includes receiving, at an application function of a core network from a user equipment (UE) device communicatively coupled to an automated vehicle, a navigation destination for the automated vehicle. The method further includes conducting, at the application function, a network health check and route validation process to determine an optimized route from a current location of the automated vehicle to the received navigation destination based on communication network traffic data. The method further includes assigning, at the application function, an optimized route with network quality (NQ) assurance. The method further includes transmitting, to the UE device, an instruction message containing the assigned optimized route.

Implementations of the method can include one or more of the following features:

The method can acknowledge, at the UE device connected to a radio access network apparatus, the assigned optimized route. The method can further include executing, at the radio access network apparatus, NQ assurance and determining network performance associated with the assigned optimized route. The method can further include, upon completion of the NQ assurance and network performance determination, providing instructions at the UE device to cause the automated vehicle to execute the assigned optimized route.

The health check and route validation process can include obtaining, using an rApp function at one or more intelligent platforms, current network traffic data from one or more radio access networks associated with one or more potential routes from the current location of the automated vehicle to the received navigation destination. The health check and route validation process can further include processing the obtained current network traffic data.

The processing can be executed using one or more machine learning (ML) models trained on historical network congestion data previously obtained from the one or more radio access networks.

The historical network congestion data can be obtained using the rApp function to at least periodically stream traffic data from the one or more radio access networks and to store the streamed traffic data in one or more databases.

The one or more machine learning models can be trained using an unsupervised training process for identifying one or more patterns of network traffic congestion at the one or more radio access networks.

The current network traffic data can be processed to predict network congestion at the one or more radio access networks associated with the one or more potential routes.

The optimized route can be assigned according to the one or more radio access networks associated with the one or more potential routes meeting one or more network requirements as determined by the processing, and the one or more network requirements can be associated with the NQ assurance.

In another general aspect, a system is provided. The system includes an interface adapted to communicate with one or more user equipment (UE) devices, a processor and a non-transitory computer-readable memory operatively connected to the processor and having stored thereon machine-readable instructions that cause, when executed, the processor to perform operations. The operations include a step to receive from a user equipment (UE) device communicatively coupled to an automated vehicle, a navigation destination for the automated vehicle. The operations further include a step to conduct a network health check and route validation process to determine an optimized route from a current location of the automated vehicle to the received navigation destination based on communication network traffic data. The operations further include a step to assign an optimized route with network quality (NQ) assurance to the automated vehicle. The operations further include a step to transmit, to the UE device, an instruction message containing the assigned optimized route.

Implementations of the system can include one or more of the following features:

The network health check and route validation process can include machine-readable instructions that cause, when executed, the processor to further obtain, using an rApp function at one or more intelligent platforms, current network traffic data obtained from one or more radio access networks associated with one or more potential routes from the current location of the automated vehicle to the received navigation destination. The network health check and route validation process can include machine-readable instructions that cause, when executed, the processor to further process the obtained current network traffic data.

The obtained current network traffic data can be processed using one or more machine learning models trained on historical network congestion data previously obtained from the one or more radio access networks.

The historical network congestion data can be obtained using the rApp function to at least periodically stream traffic data from the one or more radio access networks and to store the streamed traffic data in one or more databases.

The one or more machine learning models can be trained using an unsupervised training process for identifying one or more patterns of network traffic congestion at the one or more radio access networks.

The current network traffic data can be processed at the processor to predict network congestion at the one or more radio access networks associated with the one or more potential routes.

The optimized route can be assigned according to the one or more radio access networks associated with the one or more potential routes meeting one or more network requirements as determined by the processing, and the one or more network requirements can be associated with the NQ assurance.

In another general aspect, a method is provided for transmitting, from a user equipment (UE) device to a radio access network, a request for a route to a navigation destination, said UE device being communicatively coupled to an automated vehicle. The method further includes receiving from the radio access network an assigned optimized route with network quality (NQ) assurance at the UE device from the radio access network. The method further includes providing instructions, at the UE device for causing the automated vehicle to navigate according to the assigned optimized route upon receiving a confirmation from the radio access network that a NQ assurance has been completed.

Implementations of the method can include one or more of the following features:

The method can further include, after the receiving the optimized route at the UE device connected to the radio access network apparatus, acknowledging the assigned optimized route. The method can further include performing the instructing upon receiving a NQ assurance and network performance determination from the radio access network apparatus.

The optimized route can be assigned according to a network health check and route validation process that comprises processing current network traffic data obtained from one or more radio access networks associated with one or more potential routes from a current location of the automated vehicle to the navigation destination.

The current network traffic data can be processed to predict network congestion at the one or more radio access networks associated with the one or more potential routes.

The optimized route can be assigned according to the one or more radio access networks associated with the one or more potential routes meeting one or more network requirements as determined by the processing, and the one or more network requirements can be associated with the NQ assurance.

These and other aspects, features, and advantages can be appreciated from the following description of certain embodiments and the accompanying drawing figures and claims.

### BRIEF DESCRIPTION OF THE DRAWINGS

FIG. 1 is a schematic diagram that illustrates a system and method for autonomous routing planning according to one or more exemplary embodiments of the present disclosure.

FIG. 2 is a schematic diagram showing an overview of an unsupervised machine learning training process according to one or more exemplary embodiments of the present disclosure.

FIG. 3 is a schematic diagram showing an overview of a deployment process of the unsupervised machine learning model trained according to FIG. 2.

FIG. 4 is a schematic diagram illustrating a network environment according to one or more exemplary implementations of the present disclosure.

FIG. 5 is a schematic flow diagram for a method of planning and assigning a route for an autonomous vehicle according to one or more exemplary embodiments of the present disclosure.

FIG. 6 is a schematic diagram showing examples of a computing apparatus and a mobile computing apparatus for implementing the techniques of the present disclosure.

### DESCRIPTION OF CERTAIN EMBODIMENTS OF THE DISCLOSURE

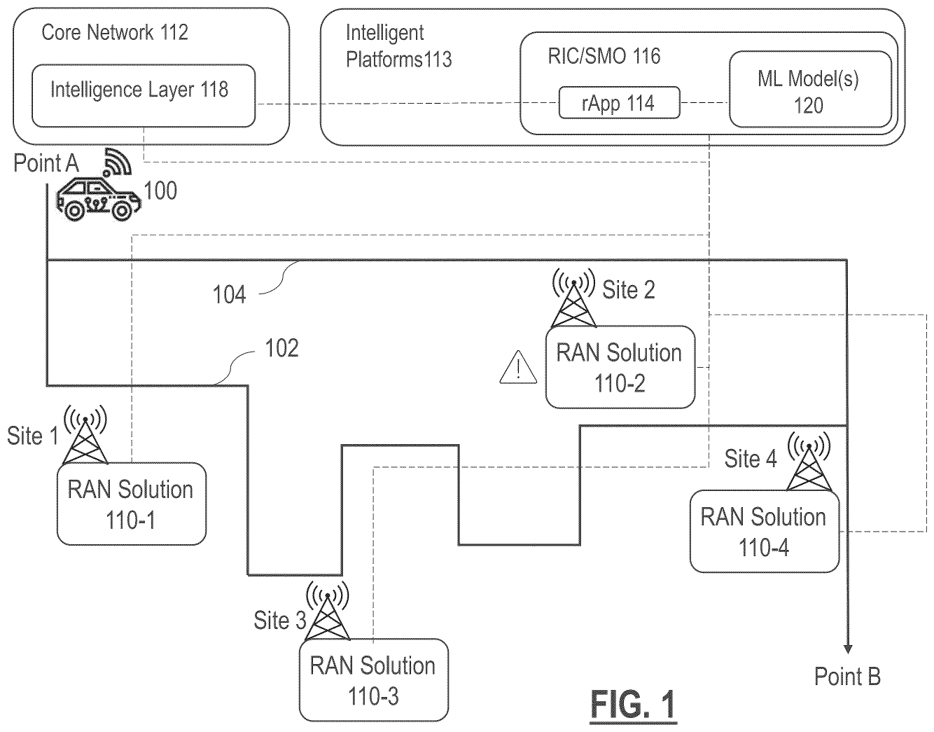

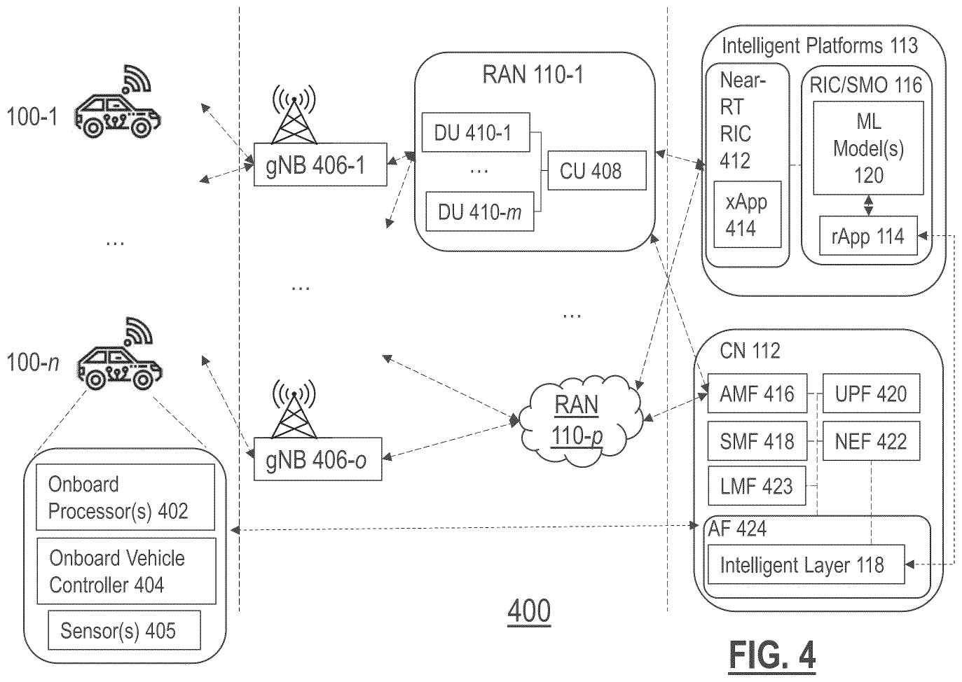

FIG. 1 is a schematic diagram that depicts an exemplary scenario illustrating a system and method of route planning for an autonomous vehicle according to one or more embodiments of the present disclosure. In the example depicted in FIG. 1, an autonomous vehicle 100 is shown positioned at an initial Point A. The autonomous vehicle 100 is instructed (e.g., by a passenger) to travel from Point A to Point B. There are alternative routes available to the vehicle 100, for example, routes 102 and 104 illustrated in FIG. 1. Along a first route 102 from Point A to Point B, there are three (3) radio access network (RAN) solution sites with base transceiver stations (BTSs), such as evolved note Bs (eNBs) and/or next generation network nodes (gNodeBs or gNBs) (see, e.g., gNB 406 in FIG. 4), that are in range of the vehicle routes for providing network coverage and services to autonomous vehicle 100, namely, Site 1 with RAN solution (or simply RAN) 110-1, Site 3 with RAN 110-3, and Site 4 with RAN 110-4. Along a second route 104, there are two (2) RAN solution sites, Site 2 with RAN 110-2 and Site 4 with RAN 110-4. As illustrated in FIG. 1, Site 4 and RAN 110-4 are available to provide network services along portions of both routes 102 and 104. In one or more exemplary implementations of the present disclosure, each of the RANs 110 comprises one or more gNBs (406 in FIG. 4) and is communicatively coupled to a core network (CN) 112 to form a cellular network architecture that conforms to a current generation radio communication standard protocol, such as the 5G network specifications (or standards) described in the 3^{rd} Generation Partnership Project (3GPP) Technical Specification (TS) 23.501, which is incorporated herein by reference as if set forth in its entirety.

The RANs 110 include air interface and transceiver portions (e.g., cell towers and associated components) as well as software for implementing central units (CUs) (408 in FIG. 4) and distributed units (DUs) (410 in FIG. 4) of, e.g., a 5G network. FIGS. 1 and 4 illustrate an Open Radio Access Network (Open RAN or O-RAN) domain architecture for intelligent platforms 113 and RAN(s) 110 that conforms to the O-RAN specifications set forth by the O-RAN Alliance, which are incorporated herein by reference in their entirely. According to one of more exemplary implementations, CUs provide support for higher layers of the protocol stack, such as service data adaptation protocol (SDAP) and radio resource control (RRC), while DUs provide support for lower layers of the protocol stack, such as media access control (MAC) and the physical layer. In one or more exemplary embodiments, each RAN 110 includes a single CU, while each CU controls multiple DUs (e.g., 410-m DUs, m>=2 in FIG. 4). Each DU can support one or more cells, or corresponding one or more radio units (RUs), so that a single RAN solution 110 can control numerous individual cells. In certain embodiments, one or more RANs 110 can include a singular DU (e.g., 410-m, m>=1).

In certain embodiments, one or more of RANs 110, CN 112, and intelligent platforms 113 can incorporate network elements that conform to standards or protocols other than those of a 5G network for operating in other network environments, such as 2G, 2.5G, 3G, 4G, Wi-Fi, WiMAX, Citizens Broadband Radio Service (CBRS) to name a few. One of ordinary skill in the art will appreciate that while the network elements are described with respect to a 5G network, other network standards are applicable to the present disclosure without departing from its spirit and scope. For example, the present disclosure contemplates a current generation radio communication standard protocol that advances beyond the 5G network standards, for example, to a 6G set of standards and so on.

As described herein, a network environment or solution (sometimes referred to herein simply as a network or an environment) refers to multiple apparatuses, modules, elements, and/or functions that incorporate hardware and/or software and operate to form one or more CNs and one or more Ans that enable wireless communication for a UE device. As described herein, a UE device includes any subscriber device that is communicatively coupled to or integrated with a vehicle control computation system, for example, a cellular telephone device, a mobile computing device, a personal computing device, an onboard vehicle control computation system with a user interface, to name a few.

Referring again to the route map shown in FIG. 1, while RAN 110-4 of Site 4 is functioning, RAN 110-2 of Site 2 can, for example, suffer from network congestion, as denoted by an alert symbol in FIG. 1. Accordingly, even though the second route 104 is shorter in terms of distance and would be preferable, for example, based on travel time, it can be problematic because wireless network coverage for vehicle 100 could be lost or suffer degradation along this route due to the congestion at RAN 110-2. Conversely, the first route 102 is longer but there is a far greater likelihood of sufficient network QoS to support autonomous driving along this second route if it is determined that neither RAN 110-1 nor RAN 110-3 suffers from network congestion.

As illustrated in FIG. 1, each of the RAN solutions 110 is communicatively coupled to a rAPP 114 that is executed at intelligent platforms 113—for example, in an O-RAN domain. In one or more exemplary implementations, rAPP 114 is implemented by a RAN Intelligence Controller (RIC) 116, which is implemented at intelligent platforms 113. According to one or more exemplary implementations, RIC 116 conforms to a non-real time service management and orchestration (SMO) framework. Correspondingly, RAN(s) 110, which incorporates CU(s) (408 in FIG. 4) and DU(s) (410 in FIG. 4), communicate with RIC/SMO 116 and rApp 114 via a near-real time (near-RT) RIC (412 in FIG. 4) and an xApp (414 in FIG. 4). Thus, near-RT RIC (412 in FIG. 4) and xApp (414 in FIG. 4) serve as communication interfaces between RIC 116 (and rApp 114) and RAN(s) 110. In certain embodiments, they can also be used to implement one or more features described herein. One of ordinary skill in the art will appreciate that features of the present disclosure can be applied to alternative RAN management environments.

Each RAN solution(s) 110 continuously streams telemetry data to rAPP 114. The telemetry data streamed by RAN solution(s) 110 includes traffic utilization and loading information, for example, from every Site 1-4, from which congestion conditions can be determined. In certain embodiments, the streamed telemetry data can be obtained by rAPP 114 via CUs (408 in FIG. 4) and/or DUs (410 in FIG. 4) of respective RAN(s) 110.

The rAPP 114 stores the obtained telemetry information (or “historical network congestion data”) in one or more historical databases of traffic utilization and loading information, referred to for convenience as “historical network congestion databases.” As illustrated in FIG. 1, CN 112 incorporates an intelligent layer 118, which communicates with autonomous vehicle 100 via RANs 110 based on the traffic data obtained by rApp 114.

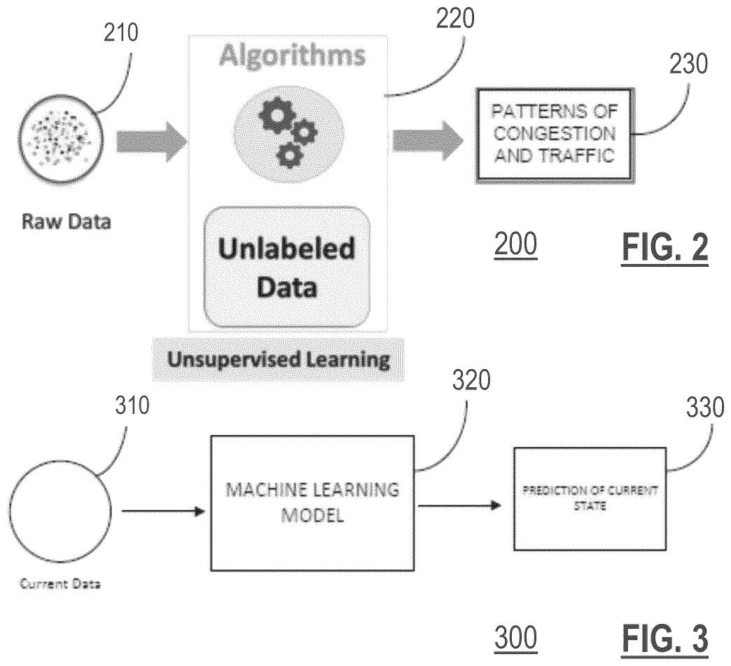

According to one or more exemplary implementations, one or more machine learning (ML) models or algorithms 120 executed at RIC 116 are trained using the traffic utilization and loading information derived from the RANs 110 via rApp 114. In some embodiments, the ML algorithms are unsupervised. FIG. 2 is a schematic diagram showing an overview of an unsupervised ML training process 200 according to one or more exemplary implementations of the present disclosure. As shown, raw data 210 comprising the historical network congestion data, for example, obtained from RAN(s) 110 and stored in one or more databases via rApp 114, is input to an unsupervised ML model 220. The raw data 210 is unlabeled, meaning that it has not received a classification from a human user or another ML classifier. The ML model 220 executes a training process based on this raw data 210 to learn patterns 230 in the data. Such patterns 230 can include, but are not limited to, patterns of congestion at one or more network locations—for example, at Sites 1-4—over time, variations in patterns of network congestion by geography, variations in network congestion along different traffic routes—for example, routes 102 and 104, to name a few. Once such patterns 230 have been recognized, the machine learning algorithm 220 can be used to process current data to yield predictions about the current state of network congestion in a network, for example, RAN(s) 110.

FIG. 3 is similar to FIG. 2 but instead of inputting historical data 210, current network congestion data 310, for example, obtained from RAN(s) 110 via rAPP 114, is input to a trained ML model 320, and the output 330 from the model provides predictions and analysis of the current state of congestion of a network, for example, RAN(s) 110. Thus, ML models 220 and 320 shown in FIGS. 2 and 3 are applicable for ML model(s) 120 shown in FIG. 1.

A number of unsupervised learning techniques can be used by machine learning model(s) 120 trained and executed at RIC 116, for example, models 220 and 320. Unsupervised machine learning technique can generally be associated with one of three categories: clustering, dimension reduction, and data mining. Clustering techniques are used to sort the raw data into clusters based on mutual similarities. Exemplary clustering techniques that can be used by model(s) 120 of rAPP 114, for example, models 220 and 320, include, but are not limited to, K-means, Hierarchical Clustering and Fuzzy C-means. Dimensionality reduction techniques reduce the dimensions of the raw data to reduce computational complexity and throughput. As an example, 4-dimensional arrays of data can be reduced to 3-dimensional arrays using techniques such as, but not limited to, principal component analysis (PCA) and linear discriminant reduction (LCR). Data mining techniques are used to determine relationships between variables in the raw data. For example, data mining can discover association rules. In the present context, one example is using data to associate certain times of day/locations pairs with elevated levels of congestion. Some of the more prevalently used data mining algorithms include Naïve Bayes, K-means, and Apriori. However, other data mining algorithms can be used.

Unsupervised machine learning techniques are particularly suited for anomaly detection, which can include unusually high or low levels of traffic and congestion or network loading. Furthermore, the unsupervised machine learning system can provide for wireless customer segmentation, by sorting customers according to travel and wireless resource use behavior, among other applications.

FIG. 4 is a schematic diagram illustrating a network environment 400 according to one or more exemplary implementations of the present disclosure. Network environment 400 includes one or more automated vehicles 100-1 . . . 100-n (n>=1), which can be partially or fully autonomous vehicles. For example, automated vehicle(s) 100 can include automated cars, buses, trucks, trams, utility vehicles, maintenance vehicles, construction vehicles, public transit vehicles, to name a few. In general, automated vehicle(s) 100 include various sensors and automated controls (including automated driving controls) by which a computational system can direct the travel (e.g., direction, speed, path, etc.) of the vehicle fully or partly without human intervention. The vehicle control computation system for each automated vehicle 100 includes one or more onboard processors 402, an onboard vehicle controller 404, and one or more position sensors 405, which are illustrated for vehicle 100-n in FIG. 4 as a representative example for vehicle(s) 100.

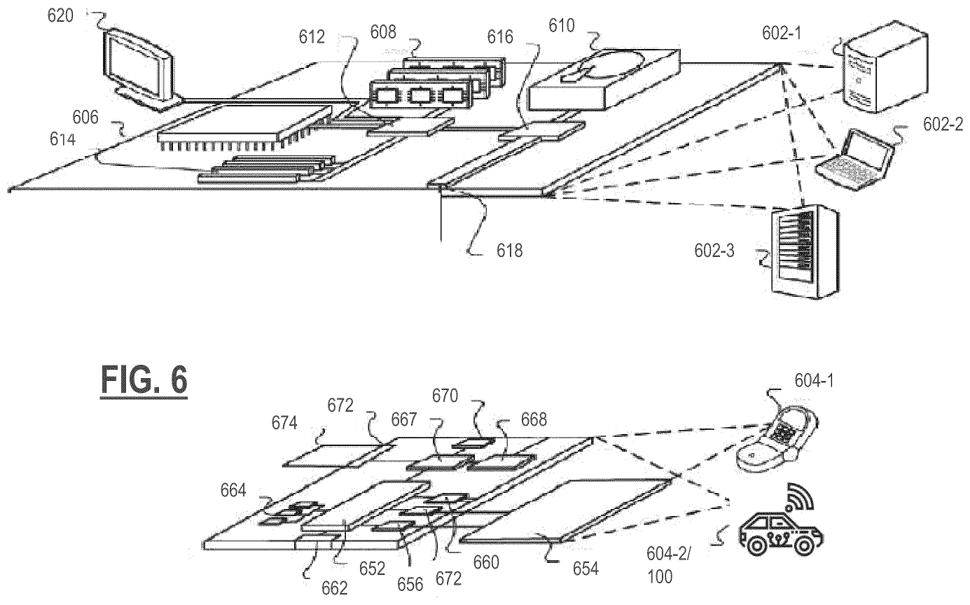

The one or more on-board computational processors (OBCPs) 402 can include one or more processor devices (606/652 in FIG. 6) and one or more memory devices (608/664 in FIG. 6), such as non-transient processor-readable memory devices. In some embodiments, each OBCP 402 includes a network interface (e.g., including any suitable antennas, transceivers, etc.) by which the automated vehicle 100 having the OBCP 402 can communicate with CN 112 via a gNB 406 and corresponding RAN 110. Processor(s) 402 and controller 404 perform navigational tasks for their vehicle 100 that involve processing data received from one or more position sensors 405. In exemplary embodiments, sensor(s) 405 can include global positioning satellite (GPS) devices, radar sensors, infrared (IR) sensors, light detection and ranging (LiDAR) sensors, cameras, proximity sensors, to name a few. Accordingly, the vehicle control computation system performs tasks that involve controlling, and processing feedback relating to braking, accelerating, steering, and other driving functions. Additional navigational tasks can involve detecting and responding to traffic rules and conditions, traffic events, such as traffic accidents, roadway damage, roadway obstructions, slow-downs, and the like.

Automated vehicle(s) 100 are in wireless communication with CN 112 via respective one or more gNBs 406-1 . . . 406-o (o>=1) and corresponding one or more RANs 110-1 . . . 110-p (p>=1). RAN 110-1 is illustrated as a representative example of RAN(s) 110-1 . . . 110-p with CU 408 and one or more DUs 410-1 . . . 410-m (m>=2) in communication with rApp 114 executed at intelligent platforms 113. One of ordinary skill in the art will appreciate that network environment 400 can include additional RANs, such as RANs 110-1 . . . 110-4 illustrated in FIG. 1, corresponding to additional gNBs 406, and additional automated vehicles 100 in communication therewith. In some embodiments, RAN(s) 110 can be coupled to one or more BTSs operating in an environment other than a 5G environment, for example, eNBs or the like. Some or all automated vehicles 100 can include antennas and transceivers through which they communicate with nearby cellular towers (or RUs) of gNBs 406, with one or more satellites, with one or more nearby relay stations, and/or with any other infrastructure that can send and receive wireless communications. In certain embodiments, vehicles 100 can communicate with CN 112 via another CN and/or associated RAN(s) 110, gNB(s) 406, BTS(s), eNB(s), or the like.

According to one or more exemplary implementations, network traffic data related to RAN(s) 110 is obtained via intelligent platforms 113, where rApp 114 of non-RT RIC/SMO 116 obtains network traffic data from RAN(s) 110 via near-RT RIC 412 and/or xApp 414. Accordingly, historical network congestion data from RAN(s) 110 is at least periodically obtained and stored in one or more databases (e.g., maintained at storage device 610 in FIG. 6), which can be maintained at one or more computing apparatuses (e.g., 602 in FIG. 6) comprised in or communicatively coupled to intelligent platforms 113. The stored historical network congestion data is used (e.g., as raw data 210 in FIG. 2) to train one or more ML models, for example, model 220, comprised in model(s) 120 to obtain one or more trained models, for example, model 320, also comprised in model(s) 120. The trained model(s) 320 can then be applied to analyze subsequently obtained network traffic data from one or more RANs 110 in correspondence with one or more vehicles 100 to determine one or more suitable routes from the current location(s) of the vehicle(s) 100 (e.g., Point A in FIG. 1) to the navigation destination(s) (e.g., Point B in FIG. 1) that would ensure QoS and/or network coverage for providing navigational instructions for automated operations of vehicle(s) 100.

FIG. 4 also illustrates domain network elements of CN 112 for communicating with vehicle(s) 100 in a manner of description associated with service-based system architectures with network elements, or network functions, interconnected via a common bus that operates in compliance with the 5G network standards. Accordingly, network function messages in CN 112 are communicated among the network elements shown in the CN 112 domain to affect higher layer services associated with vehicle(s) 100, for example, navigational instructions for automated operations of vehicle(s) 100. The lines depicted in FIG. 4 connecting the network elements in the CN 112 domain indicate possible direct communications among any two or more of the network elements. Certain processes of the present disclosure can be executed over point-to-point interfaces among the depicted network elements as can be appreciated by one of ordinary skill in the art. As one of ordinary skill in the art will also appreciate, the network elements in the CN 112 domain illustrated in FIG. 4 can be embodied as multiple respective instances serving respective ones of multiple subscribers and/or vehicles 100.

As illustrated in FIG. 4, the CN 112 domain embodies a packet core network that comprises an access and mobility management function (AMF) 416, which supports encrypted signaling associated with a user equipment (UE) device, for example, vehicle(s) 100. CN 100 further includes a session management function and packet data network gateway-control module (SMF/PGW-C) 418 that manages a session of vehicle(s) 100 and a user plane function and packet data network gateway-user plane module (UPF/PGW-U) 420 that processes and forwards user data, for example, between vehicle(s) 100 and an external data network (not shown), such as the Internet. According to one or more exemplary implementations, AMF 416 forwards messages related to session management between vehicle(s) 100 and SMF/PGW-C 418. SMF/PGW-C 418 manages UE device sessions and, in doing so, interacts with other network functions, including asserting functional control of UPF/PGW-U 420, for example, for traffic and/or quality of service (QOS) related features. In certain embodiments, AMF 416 can comprise a mobility management entity (MME) (not shown) for interoperability with 4G networks and, for example, long term evolution (LTE) RANs, which can be embodied by one or more of RANs 110.

The CN 112 domain further comprises a network exposure function (NEF) 422 that supports interactions by network functions in the CN 112 domain with applications that are executed to provide service features to a subscriber (e.g., vehicle(s) 100) and one or more application functions (AF) 424. NEF 422 provides communications to and from applications (or AF(s) 424), including providing for applications to trigger devices—for example, vehicle(s) 100, to execute actions. In accordance with one or more exemplary implementations of the present disclosure, NEF 422 mediates communications between vehicle(s) 100 and one or more Afs 424, such as one or more application features of intelligent layer 118, via AMF 416. Additionally, NEF 422 provides for data provisioning from AF(s) 424 to AMF 416 for tuning CN 112 settings, facilitating state changes for UE devices (e.g., vehicle(s) 100), and/or optimizing network signaling capacity. NEF 422 further provides certain policy (e.g., QoS) and charging controls to AF(s) 424. In certain embodiments, CN 112 can incorporate direct proprietary connections between one or more of AF(s) 424 and the other network elements, for example, AMF 416.

Intelligence layer 118 operates at least in part on an application layer in connection with executing one or more application features for CN 112 and/or vehicle(s) 100. In certain embodiments, intelligence layer 118 can be a separate network element in the CN 112 domain. According to one or more exemplary implementations, intelligence layer 118 embodies one or more application functions in AF 424 that provide analytical feedback based on historical network congestion data and/or model 320 trained on such data. The network traffic data, or historical network congestion data, accumulated by rApp 114 for training model 220/320 includes but is not limited to RAN network data, performance data, fault management data, network alarms, and network logs. Thus, network coverage and traffic information can be derived for roadway routes and respective locations along such routes based on the historical network congestion data. In certain embodiments, AF(s) 424 can further comprise one or more Application Programming Interfaces (APIs) (not shown) for providing a direct interface to one or more application features.

One or more application features associated with intelligence layer 118 can relate to a UE device location service (LCS), for example, for vehicle(s) 100. LMF 423 provides location determinations, or location services (LCS), to AMF 416, when queried, by calculating the position(s) of vehicle(s) 100) based on interactions between the vehicle(s) and a corresponding RAN 110. According to one or more exemplary implementations, LMF 423 communicates with the relevant RAN 110 for location determinations via AMF 205. In certain embodiments, the CN 112 domain further comprises a gateway mobile location center (GMLC) (not shown) that serves as an interface between AMF 416 and intelligence layer 118, for example, via AF(s) 424 and provides location determination information to one or more application features at intelligence layer 118 for location-based services (LBS). In certain embodiments, one or more gNBs 406 of a RAN 110 can be in communication with a base station controller (BSC) (not shown) and/or a serving mobile location center (SMLC) (or an evolved serving mobile location center (E-SMLC)) (not shown), which SMLC determines network-based locations of vehicle(s) 100 based on radio signal measurements.

Based on the congestion data and/or trained model 320, intelligence layer 118 provides navigational planning features to vehicle(s) 100. According to one or more exemplary implementations, intelligence layer 118 determines a route from a current location of a vehicle (Point A in FIG. 1) to a destination (Point B in FIG. 1) requested at the vehicle 100 based on customer requirements, network availability of RANs 110 along one or more potential routes (e.g., routes 102 and 104 in FIG. 1), and network traffic information. Customer requirements can include service level agreement (SLA) parameters, network connection quality and/or status, or the like. Network availability and network traffic information can include current network traffic data obtained from one or more RANs 110 (e.g. RANs 110-1 to 110-4 in FIG. 1) along one or more potential routes (e.g., routes 102 and 104 in FIG. 1) via rApp 114 and processed by ML model(s) 120 using trained model 320 (e.g., as current data 310 in FIG. 3). In one or more exemplary implementations, the current network traffic data for evaluating potential routes (e.g., 102 and 104 in FIG. 1) from a current location of a vehicle 100 (e.g., Point A in FIG. 1) to a destination requested at the vehicle 100 (e.g., Point B in FIG. 1) corresponds to the data categories in the historical network congestion data.

In certain implementations, each of some or all of the automated vehicles 100 can have a respective instance of a navigation application implemented by its local OBCP 404 and used to provide automated navigation control via its onboard vehicle controller 404. In other implementations, the navigation application is accessible to one or more OBCPs 402 of one or more automated vehicles 100 via one or more Afs 424.

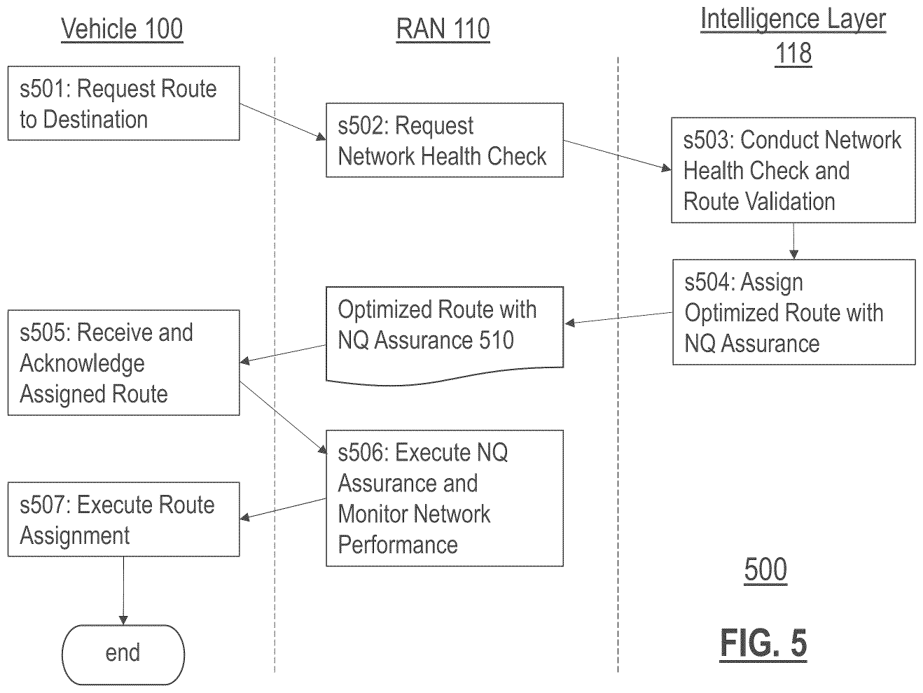

FIG. 5 is a flow diagram of a process 500 for providing navigation planning features to an automated vehicle 100 according to one or more exemplary implementations of the present disclosure. As illustrated in FIG. 5, process 500 begins with step s501, where a vehicle 100 requests a route to a destination from intelligence layer 118 via transmission(s) to a corresponding RAN 110, for example, a nearby RU of the RAN 110. The destination can be set by a user at vehicle 100 via a user interface. In certain embodiments, one or more scheduled destinations can be preprogrammed for vehicle 100.

Next, at step s502, upon receiving the route request, the RAN 110 in communication with the vehicle 100 initiates a network health check while relaying the route request to intelligence layer 118. Process 500 then proceeds to step s503, where a network health check and a route validation are conducted at intelligence layer 118.

In one or more exemplary implementations, the network health check comprises obtaining analytical feedback on current network traffic data for one or more RAN(s) 110 along each of one or more potential routes from a current location of vehicle 100 to the requested destination. The feedback is generated by processing the current network traffic data obtained from the RAN(s) 110 via rAPP 114 using ML model(s) 120, for example, trained model 320—in other words, based on historical network congestion data.

Correspondingly, route validation comprises validating network coverage and/or QoS from all RAN(s) along one or more potential routes to thereby determine an optimal route among the one or more validated routes. In one or more exemplary implementations, the network health check and route validation process evaluates one or more potential sites (e.g., sites 1-4 in FIG. 1) (or RU) along each potential route for network availability and/or network traffic information to determine whether customer requirements for providing continuous navigational features to vehicle 100 could be met for the potential route. In certain embodiments, network coverage or availability can comprise determining whether estimated cellular network signal strengths for locations along each potential route meet one or more signal strength thresholds, for example, >=−99 decibel-milliwatts (dBm), >=−89 dBm, >=−79 dBm, or the like. In certain embodiments, validating network coverage or availability can comprise determining RANs 110 associated with CN 112 along potential routes to avoid handovers to other CNs or to seek handovers from other CNs back to CN 112. In certain embodiments, the network traffic information can comprise QoS parameters, for example, maximum throughput, latency, packet loss, packet jitter, errors, signal interference, to name a few. According to one or more exemplary implementations, the aforementioned signal strength thresholds, a minimum throughput of 5 megabits per second (Mbps), and/or a maximum end-to-end delay of 20 milliseconds (ms) are set as a network quality (NQ) assurance level that is adequate for maintaining automated navigation along a potential route. In certain embodiments, additional capacity can be required for NQ assurance to maintain a Quality of Experience (QoE) to one or more other high priority or mission critical services offered in a potential route.

Upon determining one or more routes with NQ assurances, intelligence layer 118, at step s504, assigns an optimized route with NQ assurance to the vehicle 100 that requested a route at step s501 and transmits a route instruction message 510 to the vehicle via the RAN 110 of step s502. In certain embodiments, the optimized route among multiple routes with NQ assurances can be based on travel distance, traffic conditions, travel time, or the like, which can be determined based on mapping and/or traffic data from an external network, such as the Internet.

At step s505, the vehicle 100 receives the route instruction message 510 and acknowledges the assigned route, which triggers the RAN 110 in communication therewith to at step s506, execute NQ assurance and monitor network performance to complete validation of the optimized route. In one or more exemplary implementations, the RAN 110 of steps s502 and s506 validates the NQ from one or more other RANs 110 that are along the assigned optimized route based on current network performance data from such other RAN(s) 110.

Upon completion of the route validation, process 500 proceeds to step s507, where vehicle 100 assigns the optimized route to its vehicle control computation system for navigation to the destination (e.g., point B in FIG. 1) via the assigned optimized route.

FIG. 6 shows exemplary computing apparatus 602 and a mobile computing device 604 that can be used to implement the techniques described herein. Computing apparatus 602 is intended to represent various forms of digital computers, such as desktops (602-1), laptops (602-2), workstations, personal digital assistants, servers, blade servers, mainframes (602-3), and other appropriate computers. The mobile computing device 604 is intended to represent various forms of mobile devices, such as personal digital assistants, cellular telephones (604-1), smartphones, AR devices, vehicle (100) onboard computing device (604-2) and other similar computing devices. The components shown in FIG. 6, including connections and relationships, and their functions, are meant to be exemplary only, and are not meant to limit implementation of the disclosures described and/or claimed in this document.

The computing apparatus 602 can include a processor 606, a memory 608, a storage device 610, a high-speed interface 612 connecting the memory 608 and multiple high-speed expansion ports 614, and a low-speed interface 616 connecting a low-speed expansion port 618 and the storage device 610. Each of the processor 606, the memory 608, the storage device 610, the high-speed interface 612, the high-speed expansion ports 614, and the low-speed interface 616, are interconnected using various buses, and can be mounted on a common motherboard or in other manners as appropriate. The processor 606 can process instructions for execution within the computing apparatus 602, including instructions stored in the memory 608 or on the storage device 610 to display graphical information for a graphical user interface (GUI) on an external input/output device, such as a display 620 coupled to the high-speed interface 612. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 608 stores information within the computing apparatus 602. In some implementations, the memory 608 is a volatile memory unit or units. In some implementations, the memory 608 is a non-volatile memory unit or units. The memory 608 can also be another form of computer-readable medium, such as a magnetic or optical disk.

The storage device 610 is capable of providing mass storage for the computing apparatus 602. In some implementations, the storage device 610 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier and can contain instructions that, when executed, perform one or more methods, such as those described above. The computer program product can also be tangibly embodied in a computer- or machine-readable medium, such as the memory 608, the storage device 610, or memory on the processor 606.

The high-speed interface 612 can be configured to manage bandwidth-intensive operations, while the low-speed interface 616 can be configured to manage lower bandwidth-intensive operations. Of course, one of ordinary skill in the art will recognize that such allocation of functions is exemplary only. In some implementations, the high-speed interface 612 is coupled to the memory 608, the display 620 (e.g., through a graphics processor or accelerator), and to the high-speed expansion ports 614, which can accept various expansion cards (not shown). In an implementation, the low-speed interface 616 is coupled to the storage device 610 and the low-speed expansion port 618. The low-speed expansion port 618, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter (not shown).

As noted herein, computing apparatus 602 can be implemented in a number of different forms, such as a standard server, or multiple times in a group of such servers. In addition, it can be implemented in a personal computer, such as a desktop computer 602-1 or laptop computer 602-2. It can also be implemented as part of a mainframe computer 602-3 or a rack server system. Alternatively, components from the computing apparatus 602 can be combined with other components in a mobile device, such as a mobile computing device 604. Each of such devices can contain one or more of the computing apparatus 602 and the mobile computing device 604, and an entire system can be made up of multiple computing devices communicating with each other. As an example, such multiple computing devices can be implemented, at least in part, in one or more of CN 112, RAN(s) 110, and external network gNB(s) 406. Thus, ML model(s) 120 can be executed using one or more computer apparatuses 602 to process historical network congestion data obtained and stored in one or more databases maintained at one or more storage devices 610. As another example, computing apparatus 602 in the form of an integrated computing system can be implemented as the vehicle control computation system for vehicle(s) 100.

The mobile computing device 604 includes a processor 652; a memory 664; an input/output device, such as a display 654; a communication interface 667; and a transceiver 668; among other components. The mobile computing device 604 can also be provided with a storage device, such as a micro-drive or other device, to provide additional storage. Each of the processor 652, the memory 664, the display 654, the communication interface 667, and the transceiver 668, are interconnected using various buses, and several of the components can be mounted on a common motherboard or in other manners as appropriate. In some implementations, the mobile computing device 604 can include a camera device(s). The processor 652 can execute instructions within the mobile computing device 604, including instructions stored in the memory 664. The processor 652 can be implemented as a chipset of chips that include separate and multiple analog and digital processors. For example, the processor 652 can be a System on a Chip (SoC) processor, System In a Package (SIP) processor, an Application-Specific Integrated Circuit (ASIC) processor, a Complex Instruction Set Computer (CISC) processor, a Reduced Instruction Set Computer (RISC) processor, or a Minimal Instruction Set Computer (MISC) processor.

The processor 652 can provide, for example, for coordination of the other components of the mobile computing device 604, such as control of user interface (UI), applications run by the mobile computing device 604, and/or wireless communication by the mobile computing device 604. The processor 652 can communicate with a user through a control interface 658 and a display interface 656 coupled to the display 654. The display 654 can be, for example, a Thin-Film-Transistor Liquid Crystal Display (TFT) display, an Organic Light Emitting Diode (OLED) display, or other appropriate display technology. The display interface 656 can include appropriate circuitry for driving the display 654 to present graphical and other information to a user. The control interface 658 can receive commands from a user and convert them for submission to the processor 652. In addition, an external interface 662 can provide communication with the processor 652, so as to enable near area communication of the mobile computing device 604 with other devices. The external interface 662 can provide, for example, for wired communication in some implementations, or for wireless communication in other implementations, and multiple interfaces can also be used.

The memory 664 stores information within the mobile computing device 604. The memory 664 can be implemented as one or more of a computer-readable medium or media, a volatile memory unit or units, or a non-volatile memory unit or units. An expansion memory 674 can also be provided and connected to the mobile computing device 604 through an expansion interface 672, which can include, for example, a Single in Line Memory Module (SIMM) card interface. The expansion memory 674 can provide extra storage space for the mobile computing device 604, or can also store applications or other information for the mobile computing device 604. Specifically, the expansion memory 674 can include instructions to carry out or supplement the processes described above, and can include secure information also. Thus, for example, the expansion memory 674 can be provided as a security module for the mobile computing device 604, and can be programmed with instructions that permit secure use of the mobile computing device 604.

In addition, secure applications can be provided via the SIMM cards, along with additional information, such as placing identifying information on the SIMM card in a non-hackable manner. The memory can include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662. The mobile computing device 604 can communicate wirelessly through the communication interface 667, which can include digital signal processing circuitry where necessary. The communication interface 666 can provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 4G and 5G technologies. Such communication can occur, for example, through the transceiver 668 using a radio frequency. In addition, short-range communication, such as using a Bluetooth or Wi-Fi, can occur.

In addition, a Global Positioning System (GPS) receiver module 670 can provide additional navigation- and location-related wireless data to the mobile computing device 604, which can be used as appropriate by applications running on the mobile computing device 604. The mobile computing device 604 can also communicate audibly using an audio codec 660, which can receive spoken information from a user and convert it to usable digital information. The audio codec 660 can likewise generate audible sound for a user, such as through a speaker, e.g., in a handset of the mobile computing device 604. Such sound can include sound from voice telephone calls, can include recorded sound (e.g., voice messages, music files, etc.) and can also include sound generated by applications operating on the mobile computing device 604. The mobile computing device 604 can be implemented in a number of different forms—for example, as shown in FIG. 4, in a mobile phone device 604-1 or an onboard vehicle control computation system 604-2 for vehicle(s) 100. Mobile computing device 604 can also be implemented, at least in part, in a tablet device, a laptop computing device, a smartphone, a virtual reality (VR) device, an augmented reality (AR) device, or other similar mobile device. Thus, as an example, a vehicle control computation system of a vehicle 100 can comprise mobile computing device 604 for performing process 500 to obtain a validated and optimized route to a destination (e.g., Point B in FIG. 1), which is assigned for execution by an integrated onboard vehicle controller 404. In certain embodiments, a mobile phone device 604-1 can execute process 500 and communicate an assigned, validated, and optimized route to the vehicle control computation system of vehicle 100 for execution.

According to one or more exemplary implementations, CN 112, RAN(s) 105, the vehicle control computation system(s) of vehicle(s) 100, each comprises one or more of computing apparatus 602 and/or one or more of mobile computing device 604 for carrying out the above-described features using hardware and/or software components thereof. In certain embodiments, the elements of CN 112 described with reference to FIG. 4 above can be implemented, at least in part, with one or more of computing apparatus 602 and/or one or more of mobile computing device 604 using hardware and/or software components thereof. In embodiments, at least a portion of CN 112 and/or RAN(s) 110 can be implemented using a cloud infrastructure, which can comprise multiple computing apparatuses 602 and/or mobile computing devices 604.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

What is claimed is:

1. A method, comprising:
receiving, at an application function of a core network from a user equipment (UE) device communicatively coupled to an automated vehicle, a navigation destination for the automated vehicle;
conducting, at the application function, a network health check and route validation process to determine an optimized route from a current location of the automated vehicle to the received navigation destination based on communication network traffic data;
assigning, at the application function, an optimized route with network quality (NQ) assurance; and
transmitting, to the UE device, an instruction message containing the assigned optimized route.

2. The method of claim 1, further comprising:
acknowledging, at the UE device to a radio access network apparatus, the assigned optimized route;
executing, at the radio access network apparatus, NQ assurance and determining network performance associated with the assigned optimized route; and
upon completion of the NQ assurance and network performance determination, instructing, at the UE device, the automated vehicle to execute the assigned optimized route.

3. The method of claim 1, wherein the network health check and route validation process comprises:
obtaining, using an rApp function at one or more intelligent platforms, current network traffic data from one or more radio access networks associated with one or more potential routes from the current location of the automated vehicle to the received navigation destination; and
processing the obtained current network traffic data.

4. The method of claim 3, wherein the processing is executed using one or more machine learning models trained on historical network congestion data previously obtained from the one or more radio access networks.

5. The method of claim 4, wherein the historical network congestion data is obtained using the rApp function to at least periodically stream traffic data from the one or more radio access networks and to store the streamed traffic data in one or more databases.

6. The method of claim 4, wherein the one or more machine learning models are trained using an unsupervised training process for identifying one or more patterns of network traffic congestion at the one or more radio access networks.

7. The method of claim 3, wherein the current network traffic data is processed to predict network congestion at the one or more radio access networks associated with the one or more potential routes.

8. The method of claim 3, wherein the optimized route is assigned according to the one or more radio access networks associated with the one or more potential routes meeting one or more network requirements as determined by the processing, and
said one or more network requirements are associated with the NQ assurance.

9. A system, comprising:
an interface adapted to communicate with one or more user equipment (UE) devices;
a processor; and
a non-transitory computer-readable memory operatively connected to the processor and having stored thereon machine-readable instructions that cause, when executed, the processor to:
receive, from a user equipment (UE) device communicatively coupled to an automated vehicle, a navigation destination for the automated vehicle;
conduct a network health check and route validation process to determine an optimized route from a current location of the automated vehicle to the received navigation destination based on communication network traffic data;
assign an optimized route with network quality (NQ) assurance to the automated vehicle; and
transmit, to the UE device, an instruction message containing the assigned optimized route.

10. The system of claim 9, wherein the network health check and route validation process comprises machine-readable instructions that cause, when executed, the processor to further:
obtain, using an rApp function at one or more intelligent platforms, current network traffic data from one or more radio access networks associated with one or more potential routes from the current location of the automated vehicle to the received navigation destination; and
process the obtained current network traffic data.

11. The system of claim 10, wherein the obtained current network traffic data is processed using one or more machine learning models trained on historical network congestion data previously obtained from the one or more radio access networks.

12. The system of claim 11, wherein the historical network congestion data is obtained using the rApp function to at least periodically stream traffic data from the one or more radio access networks and to store the streamed traffic data in one or more databases.

13. The system of claim 11, wherein the one or more machine learning models are trained using an unsupervised training process for identifying one or more patterns of network traffic congestion at the one or more radio access networks.

14. The system of claim 10, wherein the current network traffic data is processed at the processor to predict network congestion at the one or more radio access networks associated with the one or more potential routes.

15. The system of claim 10, wherein the optimized route is assigned according to the one or more radio access networks associated with the one or more potential routes meeting one or more network requirements as determined by the processing, and
said one or more network requirements are associated with the NQ assurance.

16. A method, comprising:
transmitting, from a user equipment (UE) device to a radio access network, a request for a route to a navigation destination, said UE device being communicatively coupled to an automated vehicle;
receiving, at the UE device from the radio access network, an assigned optimized route with network quality (NQ) assurance from the radio access network; and
instructing, at the UE device, the automated vehicle to navigate according to the assigned optimized route upon receiving a confirmation from the radio access network that a NQ assurance has been completed.

17. The method of claim 16, further comprising:
after the receiving, acknowledging, at the UE device to the radio access network apparatus, the assigned optimized route; and
performing the instructing upon receiving a NQ assurance and network performance determination from the radio access network apparatus.

18. The method of claim 16, wherein the optimized route is assigned according to a network health check and route validation process that comprises processing current network traffic data obtained from one or more radio access networks associated with one or more potential routes from a current location of the automated vehicle to the navigation destination.

19. The method of claim 18, wherein the current network traffic data is processed to predict network congestion at the one or more radio access networks associated with the one or more potential routes.

20. The method of claim 18, wherein the optimized route is assigned according to the one or more radio access networks associated with the one or more potential routes meeting one or more network requirements as determined by the processing, and
said one or more network requirements are associated with the NQ assurance.
